(19) United States
(12) Patent Application Publication
(10) Pub. No.: US 2007/0139508 A1
(43) Pub. Date: Jun. 21, 2007

(54) Hand-held ink jet printer

(76) Inventor: Robert Henry Muyskens, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/314,330

(22) Filed: Dec. 21, 2005

(51) Int. Cl. B41J 3/36

(52) U.S. Cl. 347/109

(57) ABSTRACT

A hand-held ink jet printer having, an ink reservoir adapted to contain ink; a printhead in fluid communication with the ink reservoir, wherein the printhead further has a plurality of nozzles; a power source; and a controller, wherein the controller is in electrical communication with the printhead and wherein the controller is adapted to minimize vertical deviation in printing with the printhead along a horizontal plane. A method of printing with a hand-held ink jet printer comprising, measuring a vertical deviation of a print path along a horizontal plane; calculating a correction factor based on the measured vertical deviation; and applying the correction factor to the controller to minimize vertical deviation in upcoming printing.

### FIELD OF THE INVENTION

The present invention is directed to a hand-held ink jet printer, and more specifically to a unique hand-held ink jet printer with print correction capabilities and a method of using the same.

### BACKGROUND OF THE INVENTION

Ink jet printing is a conventional technique by which printing is accomplished without contact between the printing apparatus and the substrate, or medium, on which the desired print characters are deposited. Generally, ink jet printers use a series of nozzles located on the printhead of the printing apparatus to propel ink droplets onto the substrate. There are several known methods for propelling the ink through the nozzles, for example, pressurized nozzles, electrostatic fields, piezo-electric elements, and/or heaters for vapor phase droplet formation. A controller generally commands the amount of ink to be used and which nozzles will shoot the ink droplets. The image or text is built drop-by-drop and row-by-row.

Due to increased efficiency and affordability, the ink jet printer is now one of the most popular among both consumers and businesses. Therefore, ink jet printer manufacturers have a high incentive to continue developing technology in the area. This can be exemplified by the evolution of the mostly stationary desktop ink jet printer to the new mobile printing technologies.

Historically, ink jet technology has worked well when a user is printing a newly created document at the user's desk. However, difficulties have arisen when the user needed to print on pre-lined forms, odd shaped substrates, or at locations away from their desk. In order to properly print within the designated lines on the pre-printed forms, the user would either have to program the spacing into its system, use trial and error, or resort to an old fashioned typewriter. All of these methods are costly and time consuming. In addition, users would be forced to reconfigure printers to accommodate for odd substrate sizes (ex. when trying to print labels). Not to mention, many times the pre-lined forms or documents need to be printed away from the desk, like in a mailing or shipping environment.

As these drawbacks of the traditional desktop ink jet printer came to light, many manufacturers attempted to overcome them with the invent of the portable ink jet printer. Typically, the conventional portable ink jet printer weighs from about 1-6pounds and can fit into a briefcase. Most portable printers are either sheet fed or print onto a paper roll. While this has helped with the mobility issue, it has failed to solve the issue of being able to print on pre-lined documents and odd substrate sizes. As such, there is a need for an ink jet printer which allows the user the ability to print on documents and forms in ways previously unavailable. Accordingly, hand-held ink jet printers are desired.

### SUMMARY OF THE INVENTION

The present invention relates to hand-held ink jet printers. One aspect of the present invention is a hand-held ink jet printer comprising an ink reservoir adapted to contain ink; a printhead in fluid communication with the ink reservoir, wherein the printhead further comprises a plurality of nozzles; a power source; and a controller, wherein the controller is in electrical communication with the printhead and wherein the controller is adapted to minimize vertical deviation in printing with the printhead along a horizontal plane.

Another aspect of the present invention is a hand-held ink jet printer which comprises an ink reservoir adapted to contain ink; a printhead in fluid communication with the ink reservoir, wherein the printhead is comprised of a plurality of nozzles; a power source; one or more sensors, wherein at least one sensor is configured to measure deviation from a horizontal reference plane; and a controller in electrical communication with the printhead and the at least one sensor, wherein the controller is configured to receive the deviation measured by the at least one sensor, calculate a correction factor, and select an array of nozzles on the printhead based at least partly on the correction factor to adjust printing to compensate for deviation from the horizontal plane.

Yet another aspect of the present invention is a method of printing with a hand-held ink jet printer. The method comprises measuring a vertical deviation of a print path along a horizontal plane; calculating a correction factor based on the measured vertical deviation; and applying the correction factor to a controller in communication with a printhead of the ink jet printer to minimize vertical deviation in upcoming printing.

The hand-held ink jet printers of the present invention are advantageous for providing increased printing capabilities. This and other additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic view of a hand-held ink jet printer according to an exemplary embodiment of the present invention;

FIG. 2 is a schematic view of a hand-held ink jet printer according to a second exemplary embodiment of the present invention;

FIG. 3 is a schematic view of a hand-held ink jet printer according to a third exemplary embodiment of the present invention;

FIG. 4 is a schematic view of a printhead according to an exemplary embodiment of the present invention;

FIG. 5 is a schematic view of a printhead according to a fourth exemplary embodiment of the present invention; and

FIG. 6 is a diagram of a method of printing with a hand-held ink jet printer according to a fifth exemplary embodiment of the present invention.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

Reference will now be made in detail to various embodiments which are illustrated in the accompanying drawings, wherein like numerals indicate similar elements throughout the views.

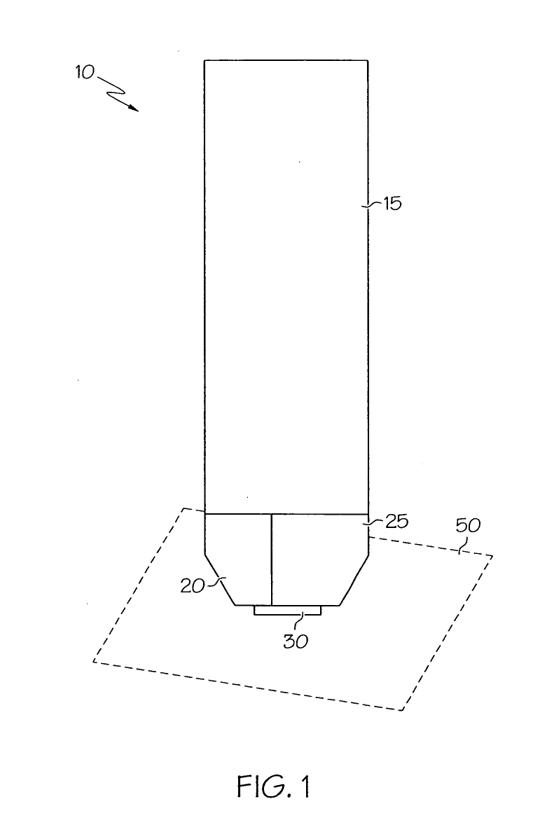

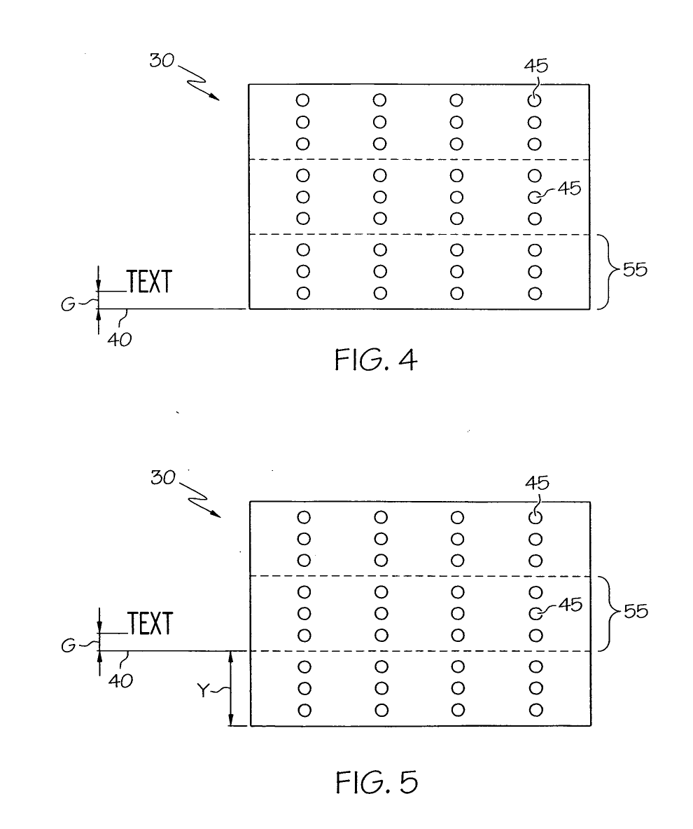

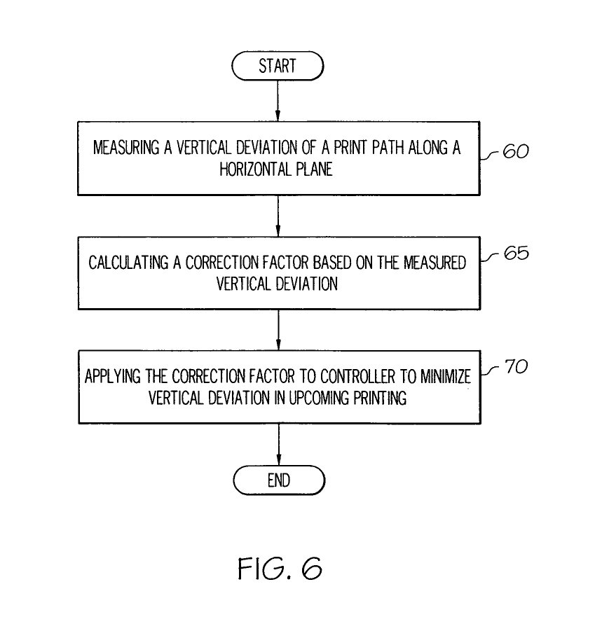

One embodiment of the present invention is illustrated by FIG. 1 and comprises a hand-held ink jet printer 10. The hand-held ink jet printer 10 comprises an ink reservoir 15 adapted to contain ink. The ink reservoir 15 can be affixed or removable to allow replacement ink or different colors or types of ink to be jetted by the hand-held printer 10. The hand-held ink jet printer 10 also comprises a printhead 30 which is in fluid communication with the ink reservoir 15. The printhead 30 is comprised of a plurality of nozzles 45 (FIG. 4). The nozzles can be arranged in any configuration, ex. vertical columns, horizontal columns, clusters, etc. The hand-held ink jet printer 10 also comprises a power source 20 and a controller 25. The controller 25 is adapted to minimize vertical deviation in printing with the printhead 30 along a horizontal plane 50.

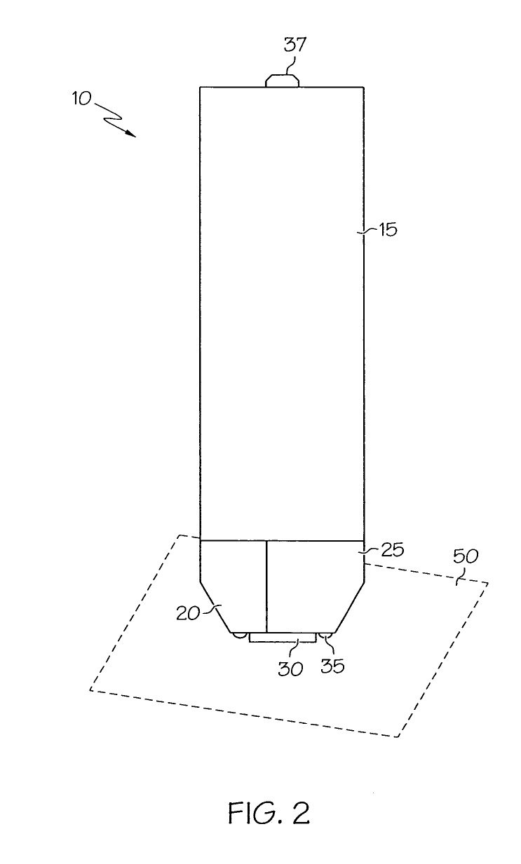

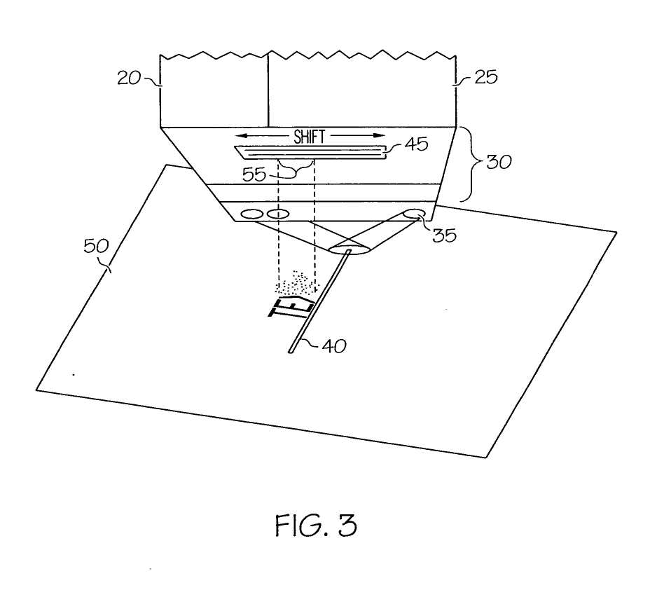

In another embodiment, illustrated by FIGS. 2 and 3, the hand-held ink jet printer 10 further comprises one or more sensors 35. The sensor 35 or sensors can be used for various tasks, for example, measuring deviation from a reference plane or line, measuring distance from a printable source, activating the controller 25, sensing the speed and/or the movement of the hand-held printer 10, etc. At least one of the sensors 35 is in electrical communication with the controller 25. In an embodiment, the sensor 35 is an optical sensor configured to measure deviation from a horizontal reference plane 50 and communicates the deviation to the controller 25. In one exemplary embodiment, the horizontal reference plane 50 contains a horizontal line 40.

In one exemplary embodiment, the controller 25 is configured to calculate a vertical correction factor based on the deviation Y and a pre-determined gap height G. This is best illustrated in FIGS. 4 and 5. In FIG. 5 the deviation Y illustrates the position of the plurality of nozzles 45 in relation to a horizontal reference line 40. The range of the deviation Y corresponds with the swath size of the printhead 30. G represents the pre-determined gap height. In other words, G is the distance the base of the text will be printed from the horizontal reference line 40. The pre-determined gap height G can be a set default which changes with the type of document being printed by the user or it can be input by the user.

In another embodiment, the controller 25 is further configured to use the vertical correction factor to select an array of nozzles 55 from the plurality of nozzles 45 on the printhead 30. Thus, the controller 25 can change which array of nozzles 55 is used to print the text. In FIGS. 4 and 5, three separate vertical arrays 55 are shown. The arrays 55, however, can be in practically any shape or form which would allow the text to be printed in the proper place. In another embodiment, the controller 25 repeats the calculation of the vertical correction factor at predetermined intervals such that the array of nozzles 55 is reselected at the predetermined intervals. So, if the user were to shift the position of the hand-held ink jet printer 10 from that of FIG. 4, to that of FIG. 5, the controller 25 would repeat the calculation which selected the bottom array of nozzles 55 in FIG. 4 and would then change the selection to that of the middle array of nozzles 55 as illustrated in FIG. 5.

In yet another exemplary embodiment of the present invention, the hand held ink jet printer 10 further comprises an input mechanism in electrical communication with the controller 25, wherein the input mechanism is configured to receive data to be printed by the printhead 30. The input mechanism could be a communication link and selected from the group consisting of: a wireless communication link, a computer readable memory card, and a computer readable memory port. In another embodiment, at least one sensor 35 is configured to signal the controller 25 to begin printing upon activation of at least one sensor 35. The at least one sensor 35 could be activated by a mode selected from the group consisting of: motion activation, manual activation, and pressure activation. In yet another embodiment, the hand-held ink jet printer 10 further comprises at least one indicator light 37, wherein the indicator light is in communication with the controller 25 and wherein the indicator light 37 is configured to indicate when the printhead moves out of the correctable print range. In another embodiment the handheld ink jet printer 10 is a pen.

Another embodiment of the present invention is a method of printing with a hand-held ink jet printer 10. The method comprises measuring a vertical deviation of a print path along a horizontal plane (60), calculating a correction factor based on the measured vertical deviation (65); and applying the correction factor to a controller to adjust for and/or minimize vertical deviation in upcoming printing (70). In an exemplary embodiment, measuring a vertical deviation comprises measuring the position of the printhead 30 with respect to a horizontal reference plane 50. This value represents Y. In one exemplary embodiment, the horizontal reference plane 50 further comprises a horizontal line 40. In another exemplary embodiment, calculating the correction factor comprises adding a pre-determined gap height G to value Y, wherein the sum represents the vertical correction factor. In another exemplary embodiment, applying the correction factor comprises selecting an array or grouping of nozzles 55 on the printhead 30 wherein the nozzles are chosen, at least in part, to minimize vertical deviation from the horizontal line 40, while still printing the desired image or text. In another exemplary embodiment, the method comprises repeating the acts of measuring a vertical deviation, calculating a correction factor and applying the correction factor at pre-determined intervals to minimize vertical deviation in upcoming printing.

The foregoing description of the various embodiments and principles of the invention has been presented for the purposes of illustration and description. It is not intended to be exhaustive or to limit the invention to the precise forms disclosed. Many alternatives, modifications and variations will be apparent to those skilled in the art. For example, some principles of the invention may be used in different ink jet pen configurations. Moreover, although multiple inventive concepts have been presented, such aspects need not be utilized in combination, and various combinations of invention aspects are possible in light of the various embodiments provided above. Accordingly, the above description is intended to embrace all possible alternatives, modifications, combinations, and variations that have been discussed or suggested herein, as well as all others that fall within the principles, spirit and broad scope of the invention as defined by the claims.

What is claimed is:

1. A hand-held ink jet printer comprising:
an ink reservoir adapted to contain ink;
a printhead in fluid communication with the ink reservoir, wherein the printhead further comprises a plurality of nozzles;
a power source; and
a controller, wherein the controller is in electrical communication with the printhead and wherein the controller is adapted to minimize vertical deviation in printing with the printhead along a horizontal plane.

2. The hand-held ink jet printer of claim 1, further comprising one or more sensors, wherein at least one of the sensors is in electrical communication with the controller and at least one sensor is configured to measure deviation from a horizontal reference plane and communicate the deviation to the controller.

3. The hand-held ink jet printer of claim 2, wherein the horizontal reference plane contains a horizontal line.

4. The hand-held ink jet printer of claim 2, wherein the controller is configured to calculate a vertical correction factor based on the deviation and a pre-determined gap height.

5. The hand-held ink jet printer of claim 4, wherein the controller is further configured to use the vertical correction factor to select one or more nozzles, from the plurality of nozzles on the printhead, to adjust printing to correct for vertical error.

6. The hand-held ink jet printer of claim 5, wherein the controller repeats the calculation at predetermined intervals such that the nozzles are reselected at the predetermined intervals.

7. The hand-held ink jet printer of claim 6, further comprising an input mechanism in electrical communication with the controller, wherein the input mechanism is configured to receive data to be printed by the printhead.

8. The hand-held ink jet printer of claim 7, wherein the input mechanism is a communication link.

9. The hand-held ink jet printer of claim 8, wherein the communication link is selected from a group consisting of: a wireless communication link, a computer readable memory card, and a computer readable memory port.

10. The hand-held ink jet printer of claim 2, wherein at least one sensor is configured to signal the controller to begin printing, upon activation of the sensor.

11. The hand-held ink jet printer of claim 10, wherein the at least one sensor is activated by a mode selected from the group consisting of: motion activation, manual activation, and pressure activation.

12. The hand-held ink jet printer of claim 2, further comprising at least one indicator light, wherein the indicator light is in communication with the controller, and wherein the indicator light is indicated when the printhead is outside a correctable print range.

13. The hand-held ink jet printer of claim 6, wherein the hand-held ink jet printer is a pen.

14. A hand-held ink jet printer comprising:
an ink reservoir adapted to contain ink;
a printhead in fluid communication with the ink reservoir, wherein the printhead is comprised of a plurality of nozzles;
a power source;
one or more sensors, wherein at least one sensor is configured to measure deviation from a horizontal reference plane; and
a controller in electrical communication with the printhead and the at least one sensor, wherein the controller is configured to receive the deviation measured by the at least one sensor, calculate a correction factor, and select an array of nozzles on the printhead based at least partly on the correction factor to adjust printing to compensate for deviation from the horizontal plane.

15. A method of printing with a hand-held ink jet printer, comprising:
measuring a vertical deviation of a print path along a horizontal plane;
calculating a vertical correction factor based on the measured vertical deviation; and
applying the vertical correction factor to a controller in communication with a printhead of the ink jet printer to minimize vertical deviation in upcoming printing.

16. The method of claim 15, wherein the measuring a vertical deviation comprises, measuring the position of the printhead with respect to a horizontal reference plane of the printing medium, wherein this value represents Y.

17. The method of claim 16, wherein the horizontal reference plane further comprises a horizontal line.

18. The method of claim 17, wherein calculating the correction factor comprises adding a pre-determined gap height value to Y.

19. The method of claim 18, wherein applying the correction factor to controller comprises selecting an array of nozzles on the printhead, wherein such array is configured to minimize vertical deviation from the horizontal line.

20. The method of claim 15, further comprising repeating the acts of measuring a vertical deviation, calculating a correction factor and applying the correction factor at pre-determined intervals.
